(19) United States
(12) Patent Application Publication
(10) Pub. No.: US 2014/0210372 A1
(43) Pub. Date: Jul. 31, 2014

(54) CONSTANT-CURRENT CIRCUIT APPARATUS OF PARALLEL LED LUMINAIRES

(71) Applicant: WELL THAI GROUP LTD, Taipei (TW)

(72) Inventor: Hsi Chang, Taipei (TW)

(73) Assignee: WELL THAI GROUP LTD, Taipei (TW)

(21) Appl. No.: 13/751,125

(22) Filed: Jan. 27, 2013

(51) Int. Cl. H05B 33/08

(52) U.S. Cl. CPC H05B 33/0842
USPC 315/294

(57) ABSTRACT

A constant-current circuit apparatus for a parallel LED luminaire is disclosed. The circuit apparatus includes an electrical connector unit and one or more parallel-connected constant-current LED light module unit. The electrical connector unit includes an input unit and an output unit connected in parallel. The current from the power source flow through the input unit of the first parallel LED luminaire to its constant-current LED light modules and through its output unit to the next parallel

LED luminaire connected to it. A constant-current LED light module unit includes an LED light module unit and a current regulation unit. The current regulation unit regulates the current at a constant value flow through the LED light module unit. The LED light module unit includes one or more LED cluster unit connected in series. Each LED cluster unit includes more than one LED component and a bypass diode connected in parallel.

### BACKGROUND OF THE INVENTION

1. Field of the Invention

The present invention relates to LED (light-emitting-diode) constant-current circuit apparatus and particularly to parallel luminaires using LED for lighting.

2. Description of Related Art

LED luminaires are now being widely accepted and promoted to replace conventional luminaires in all kinds. But, in reality, the replacement of conventional luminaires with LED luminaires is not populated as fast as one would expect. High equipment costs and un-assured life expectancy of LED luminaires are primary reasons for the lower popularity of LED luminaires in common applications.

An array of LEDs behaves different than a single LED. It can potentially create unplanned business risks, distorted end-user expectation, and diminished end-user acceptance by using the LED lumen maintenance data for projecting the lifetime behavior of an LED luminaire. Furthermore, the lifetime behavior of the LED power sources, housings, mechanical fixings, and optics could also have a great deal of impact on the life span of an LED luminaire. However, housings, mechanical fixings, and optics of an LED luminaire are manageable.

Applying one LED power source for one LED luminaire is the contemporary paradigm that almost every single luminaire manufacturer follows today. The quality of an LED power source is in direct proportion with its cost. A highly reliable and durable LED power source with high power factor and efficiency for every LED luminaire certainly makes it impossible, to reduce the cost of an LED luminaire. However, a failed LED power source fails an LED luminaire instantly. The paradox between the cost and the quality of an LED power source then becomes material significance.

Billions of switching power supplies are built each year worldwide. More than half a billion of external power supplies is retired and only 13 percent of them recycled each year in the States alone, resulting in millions of retired units going into landfills. To efficiently aggregate or eliminate multiple AC to DC conversion for LED luminaires is material significance.

An LED fails when its light output falls below a threshold expressed as a percentage of peak output. But, it can also fail catastrophically. A catastrophic LED failure can cause an instant failure in part or in whole of an LED luminaire. In part, it usually leaves a dark spot or a dark area on the luminaire that leads to the conclusion of a luminaire failure even if the light output of the luminaire is still at or above its specified level. Although the possibility of a catastrophic LED failure may be extremely low, but all other factors in shaping the lifetime of an LED luminaire aforementioned can greatly increase the possibility of the catastrophic LED failure. It could lead to lost productivity at work and increased costs in maintenance if such failure is increased.

As the number of LED components increases, the current drawn by each LED series string becomes unstable since the forward voltage of each string will be unlikely the same. The amount of resources required to minimize power loss and ensure reliability for each LED string could be relatively complicate. Most frequently used method to control the current flow through LED components is to add a simple current limiting resistor to each LED string.

Using a current limiting resistor to restrict the current flow through each LED string in a parallel configuration is economic but not as precise and reliable since the forward voltage of LED strings will be varied from one to another. When the forward voltage of LED strings is lower than the supply voltage, it will be practically impossible to achieve the same light output for all LED strings by applying a resistor with a particular resistance value for each correspondent LED string in mass productions. The LED strings will be overdriven and brighter than nominal light output if the resistance value is underestimated. On the contrary, the LED strings will be dimmer than nominal light output if the resistance value is overestimated. Overloaded current caused by underestimated resistance value of an LED string results in a reduction of LED lifetime. And, both overestimated and underestimated resistance values of LED strings produce uneven illumination in a LED luminaire as a whole. However, the even illumination is a basic requirement for any LED luminaire. Thus, using a resistor as a current limiting device to stabilize the current is not precise and reliable.

The worldwide trend to replace traditional light fixtures with LED luminaires is inevitable and immediate. The lifetime behavior of LED luminaires shapes the levels of unplanned business risks and end-user acceptance for LED luminaire markets. The performance of LED components is dominated less by their lumen maintenance and much more by the incidences of the LED catastrophic failure. Therefore, minimizing the possibility of failure with exception of individual LED quality and resolving the paradox between the cost and the quality of LED power sources in the engineering process are material significant.

### SUMMARY OF THE INVENTION

The objective of the present invention is to provide a constant-current apparatus of parallel LED luminaires to solve the aforementioned problems. A constant-current, apparatus of parallel LED luminaires with the present invention includes an electrical connector unit and one or more parallel-connected constant-current LED light module unit.

The electrical connector unit includes an input unit and an output unit connected in parallel. External constant-power LED power sources connected to primary AC power sources, or, single or multiple of DC power generating sources, including but not limited to photovoltaic (PV) solar panels, fuel cells and chemical energy batteries, provide DC power to one or more parallel LED luminaires in parallel. The current from the power source flow through the input unit and then the constant-current LED light module unit(s) of the first parallel LED luminaire. Simultaneously, the current also flow through the output unit of the first parallel LED luminaire to the next parallel LED luminaire connected to it.

A constant-current LED light module unit includes an LED light module unit and a current regulation unit connected in series. The LED light module unit includes one or more LED cluster unit connected in series. Each LED cluster unit includes more than one LED component and a bypassing diode connected in parallel. The bypassing diode is provided for each series LED cluster unit to permit continued operations with reduced light output in the event of an LED cluster unit failure. The current regulation unit restricts the current at or below a constant value flow through a constant-current LED light module unit. Constant-current light module units with, the same aforementioned configuration will then drain the same amount of current.

A parallel LED luminaire consists of one or more constant-current LED light module unit. Regardless of number of the constant-current LED light module unit included, all parallel LED luminaires will behave the same. Parallel LED luminaires in a parallel connection share DC power from the same LED power source will then have the same behavior regardless of the rated input power value or the number of the constant-current LED light module unit(s) contained in each parallel LED luminaire. All constant-current LED light module units with the same aforementioned configuration of parallel LED luminaires in the same parallel connection will drain the same amount of current for each constant-current LED light module unit at all time.

The embodiment of constant-current LED light, module unit as a basic unit in parallel for stabilizing current flow through an LED luminaire outperforms other current limiting solutions. In addition, by sharing the DC power and the cost of one single high quality LED power source, the embodiment of parallel LED luminaires resolves aforementioned paradox. There are several advantages revealed from the embodiment aforementioned stated as below:

1. A failed LED component in the embodiment has no impact on the illuminating capability of other LED components in parallel. The normal LED components in parallel in the LED cluster unit continue to emit the light in the event of one or more LED component failure. Applying more quantity of lower power LED components instead of less quantity of higher power LED components for a constant-current LED light module unit not only generates less heat but also gives less attention to the dark spot created by a failed LED. As the number of LED components increases, the spot or spots will become barely noticeable and irrelevant to end-users. The approach eliminates unnecessary maintenance works and user agony so long as the luminaire still fits for its purpose.

2. A failed LED cluster unit in the embodiment has no impact on the illuminating capability of other LED cluster units in series. A bypassing diode is used as the protection device parallel connected with all LED components of an LED cluster unit. The bypassing diode permits the current flow continuously through the LED light module unit in the event of an LED cluster unit failure.

3. A failed constant-current LED light module unit in the embodiment has no impact on the illuminating nor current-regulating capabilities of other constant-current LED light module units in parallel due to each of the constant-current LED light module units operates independently. The failed constant-current LED light module unit can be simply exchanged without replacing the whole parallel LED luminaire.

4. A failed parallel LED luminaire in the embodiment has no impact on other parallel LED luminaires in parallel. The current from the former parallel LED luminaire continuously flow through the input and output units of the failed parallel LED luminaire to the later parallel LED luminaires of a parallel connection. The replacement of the failed parallel LED luminaire is a plug-and-play process.

5. A number of parallel LED luminaires in a parallel connection share DC power from the same LED power source regardless of their rated input power value. The DC current flow through one parallel LED luminaire after another where all parallel LED luminaires in the same parallel link is controlled by a wall switch. The parallel connection capability of parallel LED luminaires simplifies the design and saves time and cost in installation and maintenance of an LED lighting system.

6. Parallel LED luminaires in the embodiment in a parallel connection shares DC current from a single DC power source. On the other hand, most LED luminaires manufactured today require an individual DC power source attached to each LED luminaire. However, a DC power source requires a pair of AC power lines for transmitting the electric power. The numbers of AC power lines required by said luminaires are much less than by later luminaires in any LED lighting system. DC current is, always safer than AC current transmitted over power lines, especially for outdoor environment. This allows electricians to quickly and safely remove or install LED luminaires without the need to shut down branch power lines or otherwise interrupt area occupants.

7. With parallel LED luminaires in the embodiment in a parallel connection sharing DC power from the same DC power source, it efficiently consolidates multiple AC to DC conversion or eliminates poor and highly fractionated power conversion.

### BRIEF DESCRIPTION OF THE DRAWINGS

FIG. 1 is a block diagram of an embodiment of a constant-current circuit apparatus of a parallel LED luminaire in accordance with the present invention;

FIG. 2 is a detail block diagram of the constant-current circuit apparatus in FIG. 1;

FIG. 3 is a schematic of a constant-current circuit apparatus in FIG. 2;

FIG. 4 is a schematic of a constant-current LED light module unit in FIG. 3;

FIG. 5 is a schematic of a current regulation unit in FIG. 3;

### DETAILED DESCRIPTION OF THE PREFERRED EMBODIMENTS

Reference will be illustrated in detail to the present preferred embodiments of the invention, examples of which are depicted in the accompanying drawings. The reference, numbers are used in the drawings and the description to indicate the parts and presented feathers, but not for limiting the specific embodiment of the present invention.

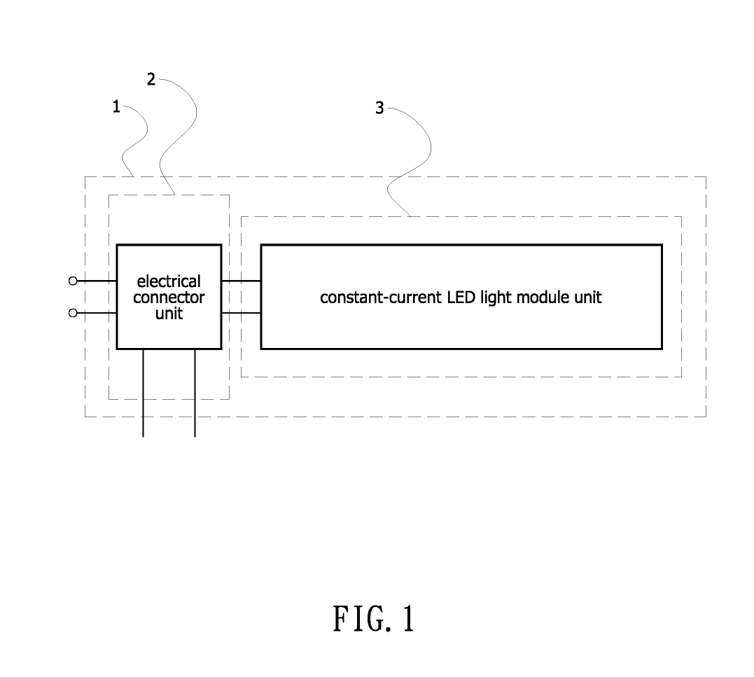

Refer to FIG. 1, the constant-current circuit apparatus of the invention 1 includes an electrical connector unit 2 and one or more constant-current LED light module unit 3.

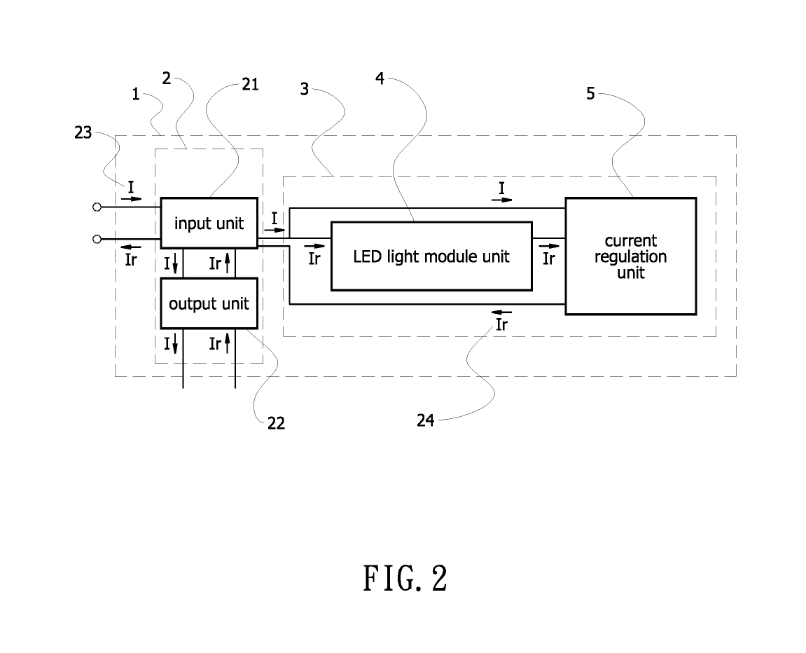

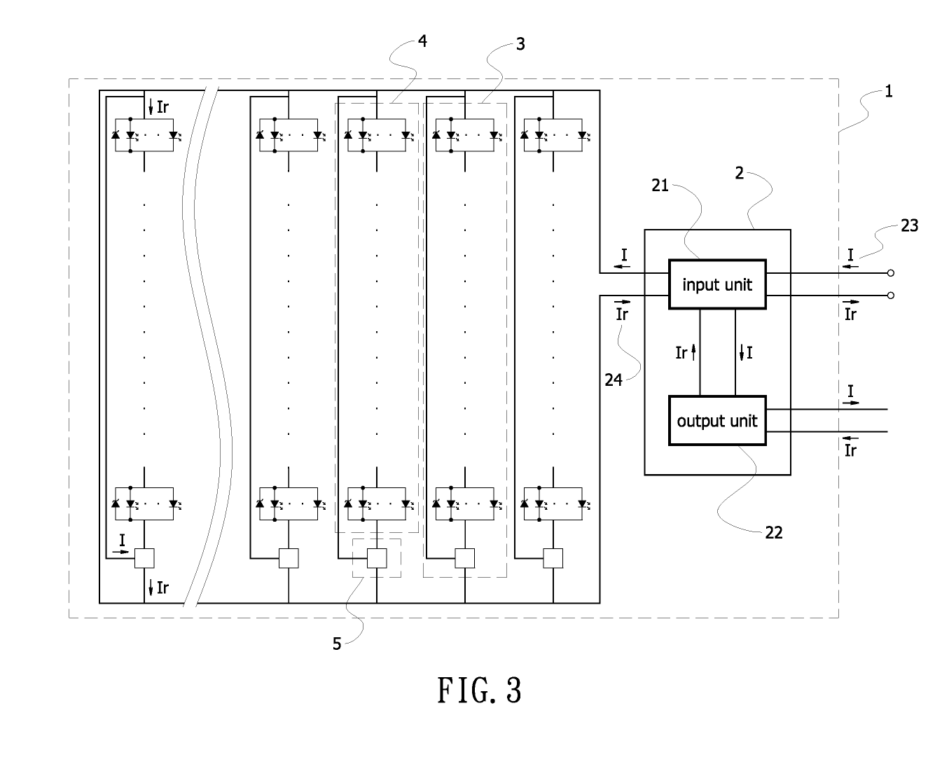

In FIG. 2, the electrical connector unit 2 includes an input unit 21 and an output unit 22. The DC forward current 23 from an external constant-power LED power source flow through the input unit 21 and send to the constant-current LED light module unit 3 of the parallel LED luminaire. Simultaneously, the DC forward current 23 flows through the output unit 22 from the input unit 21 and send to the input unit 21 of the next parallel LED luminaire in parallel. A detail description of the constant-current circuit apparatus of the invention 1 is depicted in FIG. 3.

The constant-current LED light module 3 includes one current regulation unit 5 and one LED light module unit 4 as depicted in FIG. 2 and FIG. 3. The current regulation unit 5 restricts the current 24 at or below a constant value flow through the LED light module unit 4.

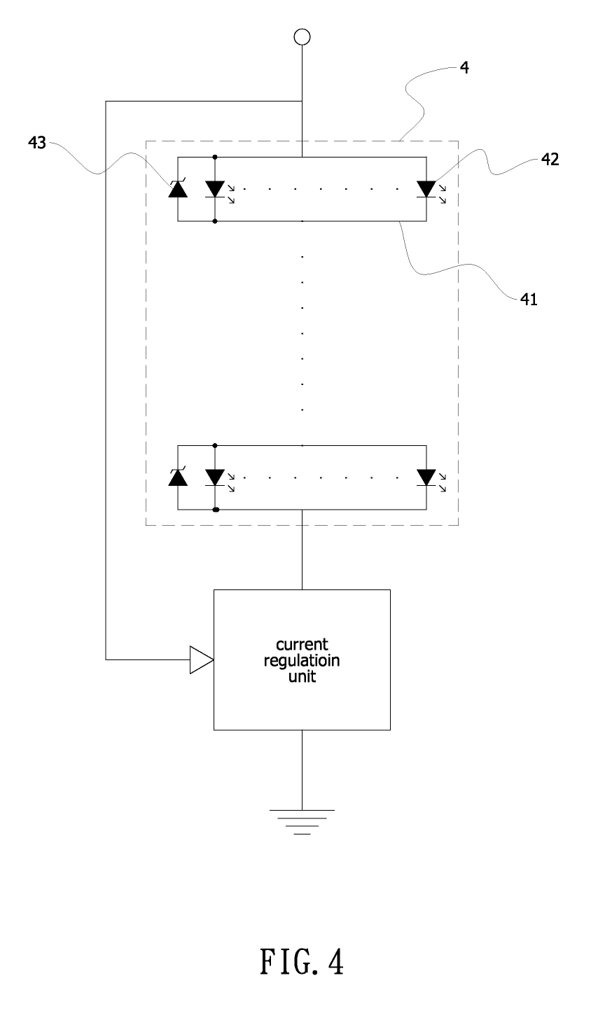

In FIG. 4, the LED light module unit 4 includes one or more LED cluster unit 41. Each LED cluster unit 41 includes more than one LED component 42 and a bypassing diode 43 connected in parallel. The normal LED components 42 in parallel in the LED cluster unit 41 continue to emit the light in the event of one or more LED component 42 failure. The bypassing diode 43 is used as the protection device permits the current continuously flow through the LED light module unit 4 in the event of an LED cluster unit 41 failure.

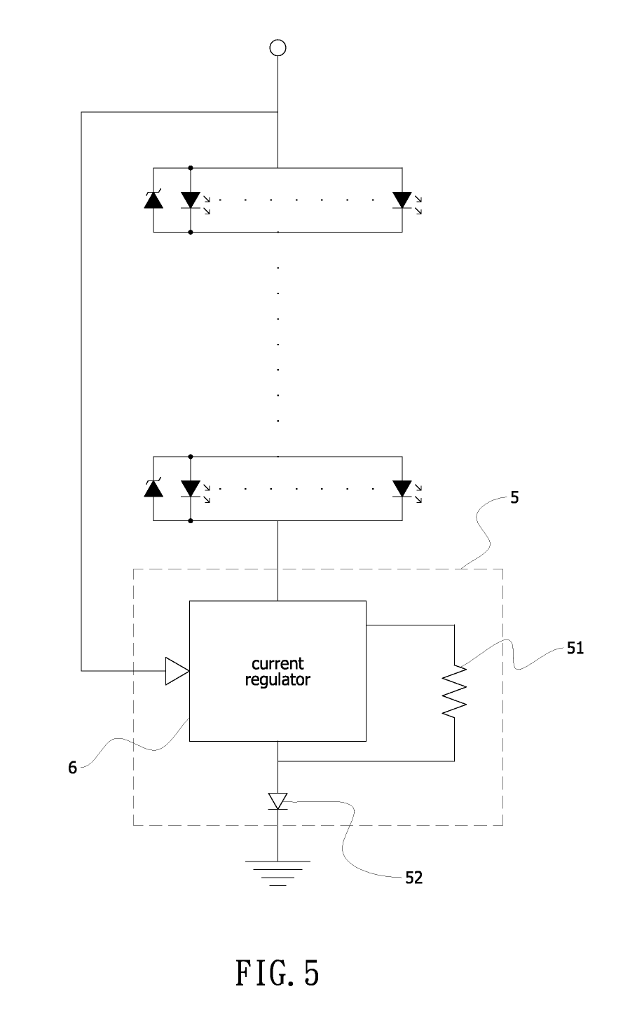

Applying a current regulator for the purpose of providing constant current is a common practice. In FIG. 5, the current regulation unit 5 includes a current regulator 6, a resistor 51, and a reverse-current diode 52. Depending on the resistance value of the resistor 51, the current regulator 6 set the current limit value to the desired level. When the current reaches the current limit, the current regulator 6 limits the current at the constant value flow through the LED light, module unit to prevent the LED light module unit from being damage by excessive current. The reverse-current diode 52 is placed to prevent the current regulator 6 from being damaged by the reverse current flow.

While the preferred embodiments of the invention have been set forth for the purpose of disclosure, modifications, of the disclosed embodiments of the invention as well as other embodiments thereof may occur to those skilled in the art. Accordingly, the appended claims hereafter may match the characteristics of what is done without departing from the spirit and scope of the invention.

What is claimed is:

1. A constant-current circuit apparatus of a parallel LED luminaire, comprising:
An electrical connector unit of a parallel LED luminaire distributes DC power through its input unit to one or more of its constant-current LED light module units and through its output unit to the input unit of the succeeded parallel LED luminaire connected to it;
A constant-current LED light module unit includes a current regulation unit and an LED light module unit connected in series;
A LED light module unit includes one or more LED cluster unit connected in series;
An LED cluster unit includes at least one LED component and a bypassing diode connected in parallel;
An LED cluster unit emits the light through at least one LED components connected in parallel;
A bypassing diode in an LED cluster is, used to ensure the continuous flow of the current throughout the LED light module unit
A linear current regulator is used in the current regulation unit to restrict the current flow at a desired current value through the LED light module unit in a constant-current LED light module unit;
A resistor is used to set the desired current value in the current regulation unit;
A reverse-current diode is used to prevent the linear current regulator from being damaged by reverse current flow;
Said parallel LED luminaire generates the light by restricting the current flow through one or more LED cluster unit in a series constant-current LED light module unit, where the LED cluster unit emits the light through at least one LED component connected in parallel.

2. A constant-current circuit apparatus of a parallel LED luminaire of claim 1, wherein said the normal LED components in the LED cluster unit continue to emit the light in the event of one or more LED component failure.

3. A constant-current circuit apparatus of a parallel LED luminaire of claim 1, wherein said the bypassing diode in the LED cluster permit a continuous flow of the current throughout the LED light module unit in the event of the LED cluster unit failure.

4. A constant-current circuit apparatus of a parallel LED luminaire of claim 1, wherein said the current regulation unit connects to one or more LED light module unit.

5. A constant-current circuit apparatus of a parallel LED luminaire of claim 1, wherein said the normal constant-current LED light module units in a parallel LED luminaire continue to emit the light in the event of one or more constant-current LED light module failure.

6. A constant-current circuit apparatus of a parallel LED luminaire of claim 1, wherein said the failed constant-current LED light module unit can be simply exchanged without replacing the whole parallel LED luminaire.

7. A constant-current circuit apparatus of a parallel LED luminaire of claim 1, wherein said the normal parallel LED luminaires in a parallel connection continue to emit the light in the event of one or more parallel LED luminaire failure.

8. A constant-current circuit apparatus of a parallel LED luminaire of claim 1, wherein said the parallel LED luminaire is hot-swapped and plug-and-play.

9. A constant-current circuit apparatus of a parallel LED luminaire of claim 1, wherein said all parallel LED luminaires in a parallel connection share DC power from the same DC power source.

10. A constant-current circuit apparatus of a parallel LED luminaire of claim 1, wherein said all parallel LED luminaires in a parallel connection share DC power from the switching power source which connects to a primary AC power source.

11. A constant-current circuit apparatus of a parallel LED luminaire of claim 1, wherein said all parallel LED luminaires in a parallel connection share DC power from single or multiple DC power generating sources, including but not limited to photovoltaic (PV) solar panels, fuel cells and chemical energy batteries.

12. A constant-current circuit apparatus of a parallel LED luminaire of claim 1, wherein said all parallel LED luminaires in a parallel connection can be simultaneously turned on and off by a traditional light switch, which serves as the electrical circuit connecting a city power source and an LED power source.

13. A constant-current circuit apparatus of a parallel LED luminaires of claim 1, wherein said all parallel LED luminaires in a parallel connection can be controlled by an LED dimmer through one or more dimming light switch.
